(19) United States
(12) Patent Application Publication
(10) Pub. No.: US 2014/0292803 A1
(43) Pub. Date: Oct. 2, 2014

(54) SYSTEM, METHOD, AND COMPUTER PROGRAM PRODUCT FOR GENERATING MIXED VIDEO AND THREE-DIMENSIONAL DATA TO REDUCE STREAMING BANDWIDTH

(71) Applicant: NVIDIA CORPORATION, Santa Clara, CA (US)

(72) Inventor: David R. Cook, San Jose, CA (US)

(73) Assignee: NVIDIA Corporation, Santa Clara, CA (US)

(21) Appl. No.: 13/854,004

(22) Filed: Mar. 29, 2013

(51) Int. Cl. G06T 11/60

(52) U.S. Cl. CPC G06T 11/60
USPC 345/619

(57) ABSTRACT

A system, method, and computer program product for generating mixed video data and three-dimensional data to reduce streaming bandwidth is disclosed. The method includes the steps of receiving graphics data that represents a plurality of graphic objects, selecting a first subset of graphic objects from the plurality of graphic objects to be rendered by a client device, transmitting the first subset of graphic objects to the client device, rendering a second subset of graphic objects from the plurality of graphic objects to generate image data for a frame of video, and transmitting the image data to the client device. The client device is configured to render the first subset of graphic objects to generate additional image data and combine the additional image data with the image data to generate a combined image for display.

### FIELD OF THE INVENTION

The present invention relates to computer-generated graphics, and more particularly to techniques for generating mixed video and three-dimensional data.

### BACKGROUND

Video gaming is a large industry that delivers content to users via conventional computer applications, game consoles, and mobile devices. Certain architectures enable games to be executed on a remote server and deliver content to a user over a network. For example, a user may execute a client application on a computer or game console that is in communication with a server application that is executing on one or more remote servers connected to the client machine over a network such as the Internet. Typically, the server application receives input from a plurality of users playing the game in parallel and generates screenshots of a viewpoint associated with each user based on three-dimensional (3D) graphics information stored on the servers. The remote servers may utilize a render farm (i.e., a plurality of nodes configured to render graphics data) to generate the screenshot by lighting, shading, rasterizing, and texturing the 3D graphics information. The resulting images are then compressed into a video stream and sent to the client application on the user's computer or console for display.

As games get more complex, the size of the models used to define the 3D graphics information has increased, thereby increasing the length of time the servers (e.g., via the render farm) require to generate the images from the graphics data. The complexity of the models used to define graphics data may limit the frame rate of the rendered video stream and can also cause what is known as lag, where the user experiences a significant time delay between when input is entered at the computer or console and when the input is translated to motion on the user's display. Furthermore, higher resolution video streams require additional bandwidth to be transmitted over the network, which further reduces the time that the servers have to complete rendering of a frame and/or reduce the number of users that may be concurrently supported by the server. Thus, there is a need for addressing this issue and/or other issues associated with the prior art.

### SUMMARY

A system, method, and computer program product for generating mixed video data and three-dimensional data to reduce streaming bandwidth is disclosed. The method includes the steps of receiving graphics data that represents a plurality of graphic objects, selecting a first subset of graphic objects from the plurality of graphic objects to be rendered by a client device, transmitting the first subset of graphic objects to the client device, rendering a second subset of graphic objects from the plurality of graphic objects to generate image data for a frame of video, and transmitting the image data to the client device. The client device is configured to render the first subset of graphic objects to generate additional image data and combine the additional image data with the image data to generate a combined image for display.

### BRIEF DESCRIPTION OF THE DRAWINGS

FIG. 1 illustrates a flowchart of a method for generating mixed video and 3D data, in accordance with one embodiment;

FIG. 2 illustrates a system that is configured to implement at least a portion of the method described in FIG. 1, in accordance with one embodiment;

FIG. 3 illustrates a parallel processing unit, according to one embodiment;

FIG. 4 illustrates the streaming multi-processor of FIG. 3, according to one embodiment;

FIG. 5A illustrates at least a portion of the server computer that generates a video stream for compositing with additional video data on a client computer, in accordance with one embodiment;

FIG. 5B illustrates a flowchart of a method for generating video data streamed to a client computer, in accordance with one embodiment;

FIG. 6A illustrates at least a portion of a client computer that generates images for display by compositing compressed video data generated by a server computer with additional image data generated by the client computer, in accordance with one embodiment;

FIG. 6B illustrates a flowchart of a method for displaying images composited from compressed video data received from a server computer and additional image data generated by a client computer, in accordance with one embodiment; and

FIG. 7 illustrates an exemplary system in which the various architecture and/or functionality of the various previous embodiments may be implemented.

### DETAILED DESCRIPTION

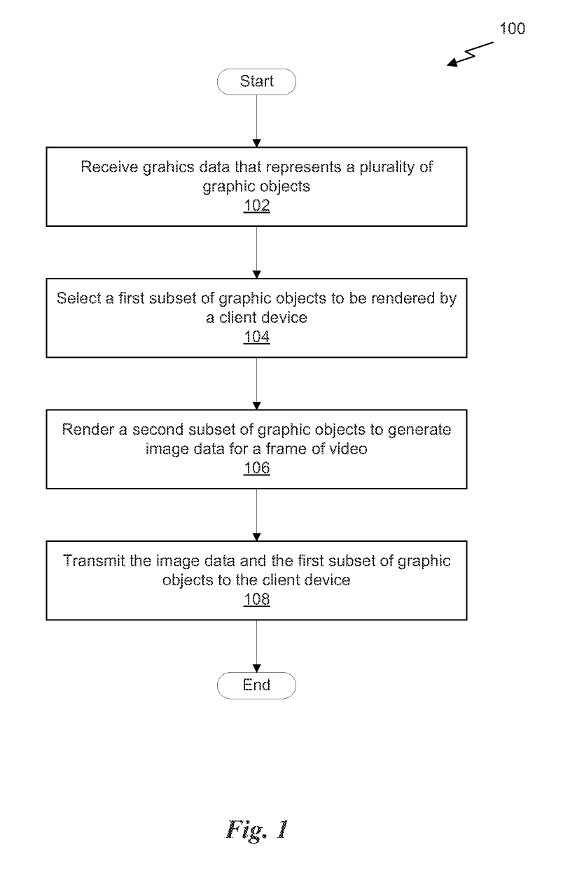

FIG. 1 illustrates a flowchart 100 of a method for generating mixed video and 3D data, in accordance with one embodiment. At step 102, a first device receives graphics data that represents a plurality of graphic objects. In one embodiment, the first device is a server computer in a server-client architecture that is coupled to a client computer via a network. At step 104, the first device selects a subset of graphic objects to be rendered by a second device. In one embodiment, the second device is the client computer and is connected to the server computer via the Internet. At step 106, the first device renders a second subset of graphic objects to generate image data for a frame of video. The image data does not contain pixel data associated with the graphic objects in the first subset of graphic objects, which will be rendered by the second device.

At step 108, the first device transmits the image data and the first subset of graphic objects to the client device. The client device is configured to render the first subset of graphic objects to generate additional image data that is combined with the image data to generate a combined image for display.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

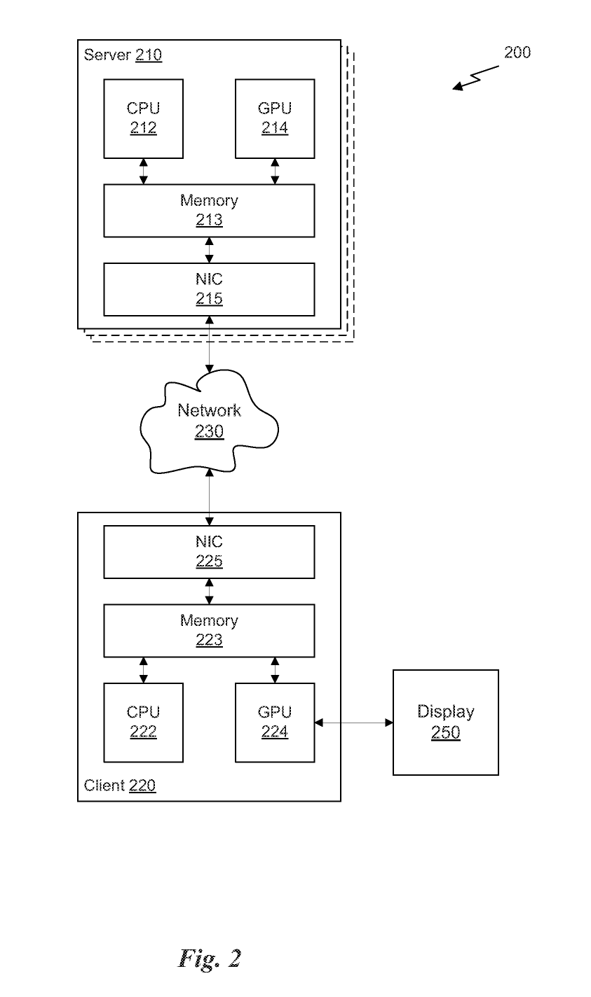

FIG. 2 illustrates a system 200 that is configured to implement at least a portion of the method described in FIG. 1, in accordance with one embodiment. As shown in FIG. 2, the system 200 includes a server computer 210 and a client computer 220 connected via a network 230. The network 230 may be the Internet, a wireless local area network (WLAN), a mesh network, a local area network (LAN) over Ethernet, or some other type of network. The network 230 may be wired (i.e., IEEE 802.3) or wireless (i.e., IEEE 802.11). In one embodiment, the server computer 210 may be a desktop computer coupled to a LAN. The server computer 210 may be running software that configures the desktop computer as a server in the client-server model. In another embodiment, the server computer 210 is a blade server located remotely and coupled to the network 230 via a TCP/IP software stack. In yet another embodiment, the server computer 210 is a scalable service implemented in the cloud (i.e., service delivered over a network) and executed on one or more physical nodes coupled to the network 230. In still another embodiment, the server computer 210 is implemented as a plurality of nodes connected to the network 230, where at least one node is configured as a master node and at least one other node is configured as a render farm (i.e., a plurality of nodes configured to render 3D graphics in parallel). The client computer 220 may be a desktop computer, laptop computer, tablet computer, hand-held mobile device (e.g., cellular phone, Apple™ iPod, etc.), a gaming console (e.g., Sony™ Playstation, Nintendo™ Wii, etc.), a mobile gaming console (Sony™ Playstation Vita, NVIDIA™ Shield, etc.), or some other electronic device. The client computer 220 may be running software that configures the desktop computer as a client in the client-server architecture. In the client-server model, the server makes resources available to the client and the client contacts the server to request access to those resources. The server computer 210 provides the client computer 220 with graphics rendering resources (i.e., one or more graphics processing units 214) as well as other data processing capabilities such as communication with one or more other client computers (not explicitly shown).

As shown in FIG. 2, each of the server computers 210 includes a CPU 212 and a GPU 214 coupled to a memory 213 such as a dynamic random access memory (DRAM). Each of the server computers 210 also includes a network interface controller (NIC) 215 that enables the server computer 210 to communicate with the client computer 220 over the network 230. The NIC 215 provides a physical layer as well as a data link layer in the OSI (Open Systems Interconnection) networking model. The CPU 212 may implement a TCP/IP software stack that enables the communications to be implemented using Internet Protocol (IP) addresses for each node in the network, as is well-known in the art.

Similarly, the client computer 220 also includes a CPU 222, a GPU 224, a memory 223, and a NIC 225. The CPU 222, the GPU 224, the memory 223, and the NIC 225 are similar to the CPU 212, the GPU 214, the memory 213, and the NIC 215 of the server computer 210. The client computer 220 may include an application that is stored in the memory 223 and is configured to communicate with an application running on the server computer 210. Furthermore, the GPU 224 is coupled to a video interface such as a VGA (Video Graphics Array), DVI (Digital Visual Interface), or DP (DisplayPort). The client computer 210 is coupled to a display device 250 such as a liquid crystal display (LCD) that includes an array of pixels for display images at a particular refresh rate. Alternatively, the display device 250 may be other types of display devices known in the art such as a CRT (Cathode Ray Tube) or a OLED (Organic Light Emitting Diode) display.

In one embodiment, the server computer 210 (or server computers) is configured to generate video data (i.e., a plurality of images) for display on the display device 250 connected to the client computer 220. The server computer 210 may include an application and a model that comprises 3D graphics data representing a plurality of 3D graphic objects. The application and the model may be stored in the memory 213. As is known in the art, the graphics data may comprise a plurality of graphics primitives such as triangles, quads, triangle strips (or fans), lines, points, and other types of graphics primitives that define a plurality of vertices and surfaces for a 3D model. The model may also include one or more texture maps as well as one or more custom shader programs defined to process the model data. The GPU 214 is configured to process the 3D graphics data, based on a viewpoint associated with an application running on the client computer 220, to generate images for display on the display device 250. The server computer 210 may generate one image for each frame of video to be displayed on the display 250. A single image may be transmitted to the client computer 220 for display or multiple images may be buffered and compressed into digital video that is streamed to the client computer 220.

The amount a particular frame of video can be compressed may depend on the content of the frame. For example, a video frame that is a surface where every pixel in the surface is the same color can be compressed very efficiently. In addition, a video frame that is very similar to a previous video frame (or a succeeding video frame) can be efficiently compressed using data from the preceding (or succeeding) frame of video. Such efficiencies are described in the MPEG-Part 4 AVC codec as well as the H.264 codec.

In one embodiment, in order to reduce the bandwidth required to transmit the image data (or video data) to the client computer 210, the server computer 220 will analyze the graphics data to determine a subset of graphic objects in the model that can be rendered by the client computer 220. For example, some graphical applications such as video games include 3D graphic objects that can be considered part of a heads-up-display (HUD). For example, in first-person shooter games, the surface generated may include a representation of the player's weapon, such as a gun, or a part of the player's character. In addition, some games allow a person to view a representation of the player's character from a third-person perspective. In such circumstances, the server computer 210 may select the graphic objects that comprise the HUD and transmit a copy of those graphic objects to the client computer 220 to be rendered locally via the GPU 224. The server computer 210 may also keep a copy of the graphic objects included in the HUD on the server computer 210 in order to determine which of the other objects or portions of objects may be occluded by the graphic objects in the HUD. It will be appreciated, that in other embodiments, the server computer 210 may select different subsets of objects to be rendered by the client computer 220. For example, in one embodiment, the server computer 210 may select objects less than a certain depth in the scene to be rendered by the client computer 220. In other words, objects in the foreground can be rendered locally by the client computer 210 while objects in the background are rendered by the server computer 210 and transmitted to the client as either compressed or uncompressed video data. In yet other embodiments, the server computer 210 may select objects located greater than a certain depth in the scene to be rendered by the client computer 220. Thus, objects in the background may be rendered locally by the client computer 220 while objects in the foreground of the scene are rendered by the server computer 210 and transmitted to the client computer 220 as compressed video data.

In one embodiment, the server computer 210 identifies specific depth ranges relative to the surface of the video. For example, the video may be identified as a surface at a specific depth in the scene. The client computer 220 may then combine the locally rendered objects with the video data using the depth of the surface of the video. In one embodiment, the depth ranges are in front of the surface of the video. In another embodiment, the depth ranges are behind the surface of the video. In yet another embodiment, depth ranges may be defined as either in front of or behind each section of the surface of the video, where a first subset of the surface of video is in front of the depth ranges (i.e., a portion of the video represents a foreground) and a second subset of the surface of the video is behind the depth ranges (i.e., a portion of the video represents a background). The client machine 220 may then combine the locally rendered objects with the video data based on the depth ranges relative to the surface of the video.

In one embodiment, the server computer 210 selects a subset of graphic objects to be rendered locally by the client computer 220 and transmits a copy of the subset of graphic objects to the client computer 220 to be stored locally in the memory 223. The server computer 210 then renders a frame of video data to generate an image for display on the display device 250. The server computer 210 may render each of the graphic objects included in a scene that are not included in the subset of graphic objects transmitted to the client computer 220. In one embodiment, the GPU 214 performs a first pass on all of the graphic objects in the scene to generate a depth buffer that includes a depth for all opaque objects at each pixel position in the surface to be rendered. The depth buffer includes depths associated with graphic objects in the subset of graphic objects transmitted to the client computer as well as graphic objects that are not included in the subset of graphic objects. Then, the GPU 214 performs a second pass on the graphic objects in the scene that are not included in the subset of graphic objects transmitted to the client computer 220. The second pass renders visible portions of the graphic objects rendered by the server computer 210 to a logical surface in memory 213 that represents the digital image to be displayed on the display device 250. For each graphic object (e.g., triangle), the GPU 214 determines which pixels of the surface are covered by the graphic object and compares a depth associated with each covered pixel to a corresponding depth in the depth buffer. If the depth of the graphic object at that pixel location is equal to the corresponding depth stored in the depth buffer (i.e., meaning the graphic object is visible at that pixel location), then the GPU 214 renders the graphic object at that pixel location and stores the generated pixel data in a frame buffer for the surface. Once all of the graphic objects that are visible in the scene and not included in the subset of graphic objects transmitted to the client computer 220 have been rendered, the server computer 210 copies the frame buffer into a data structure in memory 213 that represents the image data for that frame of video.

In another embodiment, the GPU 214 fills a stencil buffer by rendering each of the graphic objects included in the subset of graphic objects transmitted to the client computer 220. The stencil buffer represents a mask of pixel data in the frame of video data that will be generated by the client computer 210. The GPU 214 then renders each of the graphic objects rendered by the server computer 210 to generate pixel data for the frame of video. The pixel data is only added to the frame buffer after passing the stencil buffer test, meaning that the pixel data is not occluded by a pixel for graphic objects to be rendered by the client computer 220.

It will be appreciated that, before rendering a frame of video data, the frame buffer may be initialized by the GPU 214 such that any pixels in the frame buffer that are associated with pixels that represent portions of graphic objects transmitted to the client computer 220 are a constant value. For example, every pixel in the frame buffer may be initialized to be a specific color (e.g., RGBA values of 0x00, 0x00, 0x00, 0x00, respectively). Thus, compression of adjacent pixels that are associated with pixels that represent portions of graphic objects transmitted to the client computer 220 may be compressed efficiently. In another embodiment, each pixel may be initialized with a minimum value for the alpha channel of the pixel, where the minimum value represents a fully transparent pixel. Thus, blending such pixels with image data generated by the client computer 220 will result in a pixel that represents the graphic object transmitted to the client computer 220 and not a background color generated by the server computer 210.

In one embodiment, the server computer 210 transmits each frame of video, uncompressed, to the client computer 220. Even though the bandwidth for the uncompressed video data may be the same as if the server computer 210 would have rendered every graphic object in the scene, advantages can be gained due to load balancing between the server computer and the client computer that enables higher frame rates than if only the server computer 210 or only the client computer 220 rendered the entire scene. In another embodiment, the server computer 210 compresses the frame of video data (e.g., using a run-length encoding scheme or a JPEG codec). In yet another embodiment, the frame of video data may be buffered and compared with one or more preceding or succeeding frames of video data to generate a compressed video stream such as MPEG compliant video data or H.264 compliant video data. After the frame of video has been encoded, the compressed video data for the frame of video is transmitted to the client computer 220, where the compressed video data is decoded and blended with additional image data for the frame of video generated by the GPU 224 of the client computer 220.

In one embodiment, the server computer 210 transmits any state information associated with the graphic objects in the scene to the client computer 220. For example, state information may represent input from one or more other client computers as well as the client computer 220 that cause the application on the server computer 220 to make transformations to the model data. For example, a user may use a keyboard or control joystick to “move” a character, thereby affecting the viewpoint of the scene to be rendered. Similarly, the application on the server computer 220 may perform physics calculations that affect the relative positioning between graphic objects in the scene. To prevent the server computer 210 from having to resend a copy of any transformed graphic objects in the subset of graphic objects transmitted to the client computer 220 in between each frame, the server computer 210 may simply transmit commands that indicate to an application running in the client computer 220 how the locally stored graphic objects should be transformed. The application running in the client computer 220 may then update the locally stored copies of the graphic objects before rendering data for the next frame of video.

The client computer 220, via the GPU 224, renders the subset of graphic objects transmitted to the client computer 220 to generate additional image data for display. The client computer renders the graphic objects in the subset of graphic objects transmitted to the client computer 220 similarly to the method described above by the server computer 220. The resulting image data is then blended with the decoded image data for the frame of video received from the server computer 210. In one embodiment, the server computer 210 encodes metadata in the stream of video data that indicates timing information for each frame of video. In other words, a timestamp may be included in the video stream that marks a time associated with each frame of video. The client computer 220 may utilize this metadata to synchronize the decoded frames of video data to the additional image data generated by the client computer 220. Once the client computer 220 has blended the additional image data with the decoded frame of video to generate composite image data, the composite image data is transmitted to the display device 250 for display to a user.

It will be appreciated that the GPUs 214 and 224 implemented within each of the server computer 210 and the client computer 220, respectively, may be a parallel processing unit implemented on a graphics card or as a graphics core within a system-on-chip (SoC) or equivalent. One such parallel processing unit is described below.

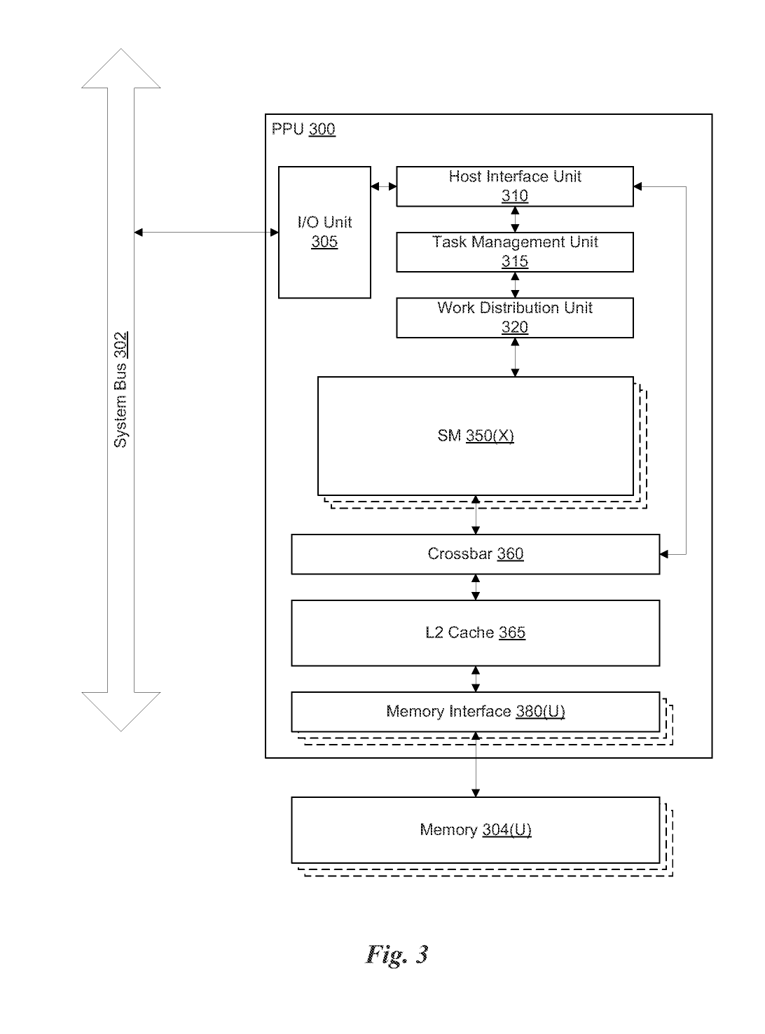

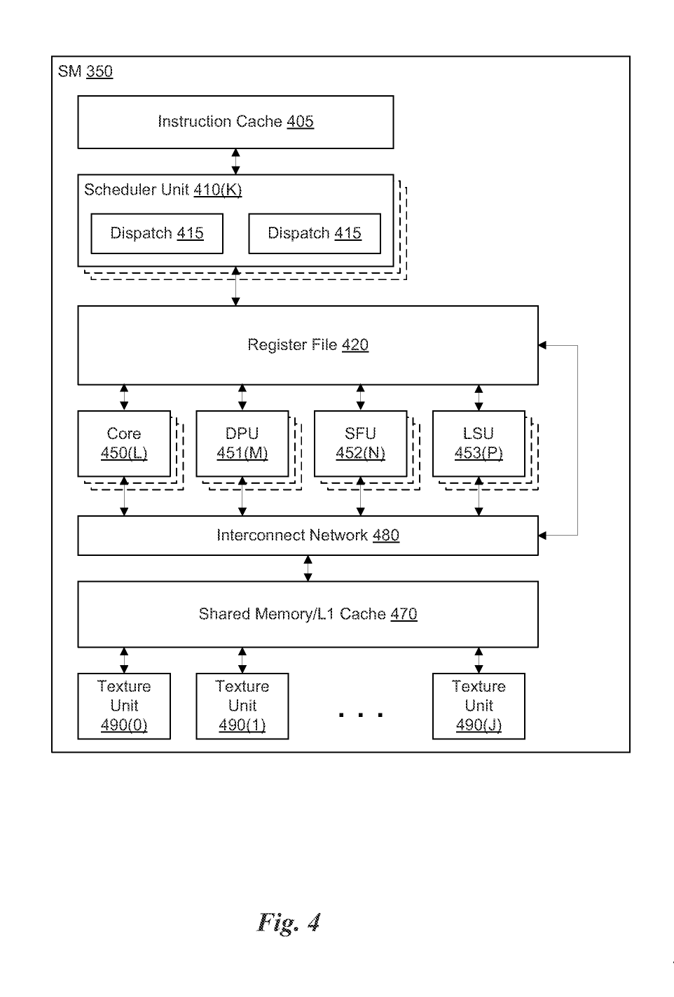

FIG. 3 illustrates a parallel processing unit (PPU) 300, according to one embodiment. While a parallel processor is provided herein as an example of the PPU 300, it should be strongly noted that such processor is set forth for illustrative purposes only, and any processor may be employed to supplement and/or substitute for the same. In one embodiment, the PPU 300 is configured to execute a plurality of threads concurrently in two or more streaming multi-processors (SMs) 350. A thread (i.e., a thread of execution) is an instantiation of a set of instructions executing within a particular SM 350. Each SM 350, described below in more detail in conjunction with FIG. 4, may include, but is not limited to, one or more processing cores, one or more load/store units (LSUs), a level-one (L1) cache, shared memory, and the like.

In one embodiment, the PPU 300 includes an input/output (I/O) unit 305 configured to transmit and receive communications (i.e., commands, data, etc.) from a central processing unit (CPU) (not shown) over the system bus 302. The I/O unit 305 may implement a Peripheral Component Interconnect Express (PCIe) interface for communications over a PCIe bus. In alternative embodiments, the I/O unit 305 may implement other types of well-known bus interfaces.

The PPU 300 also includes a host interface unit 310 that decodes the commands and transmits the commands to the task management unit 315 or other units of the PPU 300 (e.g., memory interface 380) as the commands may specify. The host interface unit 310 is configured to route communications between and among the various logical units of the PPU 300.

In one embodiment, a program encoded as a command stream is written to a buffer by the CPU. The buffer is a region in memory, e.g., memory 304 or system memory, that is accessible (i.e., read/write) by both the CPU and the PPU 300. The CPU writes the command stream to the buffer and then transmits a pointer to the start of the command stream to the PPU 300. The host interface unit 310 provides the task management unit (TMU) 315 with pointers to one or more streams. The TMU 315 selects one or more streams and is configured to organize the selected streams as a pool of pending grids. The pool of pending grids may include new grids that have not yet been selected for execution and grids that have been partially executed and have been suspended.

A work distribution unit 320 that is coupled between the TMU 315 and the SMs 350 manages a pool of active grids, selecting and dispatching active grids for execution by the SMs 350. Pending grids are transferred to the active grid pool by the TMU 315 when a pending grid is eligible to execute, i.e., has no unresolved data dependencies. An active grid is transferred to the pending pool when execution of the active grid is blocked by a dependency. When execution of a grid is completed, the grid is removed from the active grid pool by the work distribution unit 320. In addition to receiving grids from the host interface unit 310 and the work distribution unit 320, the TMU 215 also receives grids that are dynamically generated by the SMs 350 during execution of a grid. These dynamically generated grids join the other pending grids in the pending grid pool.

In one embodiment, the CPU executes a driver kernel that implements an application programming interface (API) that enables one or more applications executing on the CPU to schedule operations for execution on the PPU 300. An application may include instructions (i.e., API calls) that cause the driver kernel to generate one or more grids for execution. In one embodiment, the PPU 300 implements a SIMD (Single-Instruction, Multiple-Data) architecture where each thread block (i.e., warp) in a grid is concurrently executed on a different data set by different threads in the thread block. The driver kernel defines thread blocks that are comprised of k related threads, such that threads in the same thread block may exchange data through shared memory. In one embodiment, a thread block comprises 32 related threads and a grid is an array of one or more thread blocks that execute the same stream and the different thread blocks may exchange data through global memory.

In one embodiment, the PPU 300 comprises X SMs 350(X). For example, the PPU 300 may include 15 distinct SMs 350. Each SM 350 is multi-threaded and configured to execute a plurality of threads (e.g., 32 threads) from a particular thread block concurrently. Each of the SMs 350 is connected to a level-two (L2) cache 365 via a crossbar 360 (or other type of interconnect network). The L2 cache 365 is connected to one or more memory interfaces 380. Memory interfaces 380 implement 16, 32, 64, 128-bit data buses, or the like, for high-speed data transfer. In one embodiment, the PPU 300 comprises U memory interfaces 380(U), where each memory interface 380(U) is connected to a corresponding memory device 304(U). For example, PPU 300 may be connected to up to 6 memory devices 304, such as graphics double-data-rate, version 5, synchronous dynamic random access memory (GDDR5 SDRAM).

In one embodiment, the PPU 300 implements a multi-level memory hierarchy. The memory 304 is located off-chip in SDRAM coupled to the PPU 300. Data from the memory 304 may be fetched and stored in the L2 cache 365, which is located on-chip and is shared between the various SMs 350. In one embodiment, each of the SMs 350 also implements an L1 cache. The L1 cache is private memory that is dedicated to a particular SM 350. Each of the L1 caches is coupled to the shared L2 cache 365. Data from the L2 cache 365 may be fetched and stored in each of the L1 caches for processing in the functional units of the SMs 350.

In one embodiment, the PPU 300 comprises a graphics processing unit (GPU). The PPU 300 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 300 can be configured to process the graphics primitives to generate a frame buffer (i.e., pixel data for each of the pixels of the display). The driver kernel implements a graphics processing pipeline, such as the graphics processing pipeline defined by the OpenGL API.

An application writes model data for a scene (i.e., a collection of vertices and attributes) to memory. The model data defines each of the objects that may be visible on a display. The application then makes an API call to the driver kernel that requests the model data to be rendered and displayed. The driver kernel reads the model data and writes commands to the buffer to perform one or more operations to process the model data. The commands may encode different shader programs including one or more of a vertex shader, hull shader, geometry shader, pixel shader, etc. For example, the TMU 315 may configure one or more SMs 350 to execute a vertex shader program that processes a number of vertices defined by the model data. In one embodiment, the TMU 315 may configure different SMs 350 to execute different shader programs concurrently. For example, a first subset of SMs 350 may be configured to execute a vertex shader program while a second subset of SMs 350 may be configured to execute a pixel shader program. The first subset of SMs 350 processes vertex data to produce processed vertex data and writes the processed vertex data to the L2 cache 365 and/or the memory 304. After the processed vertex data is rasterized (i.e., transformed from three-dimensional data into two-dimensional data in screen space) to produce fragment data, the second subset of SMs 350 executes a pixel shader to produce processed fragment data, which is then blended with other processed fragment data and written to the frame buffer in memory 304. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

The PPU 300 may be included in a desktop computer, a laptop computer, a tablet computer, a smart-phone (e.g., a wireless, hand-held device), personal digital assistant (PDA), a digital camera, a hand-held electronic device, and the like. In one embodiment, the PPU 300 is embodied on a single semiconductor substrate. In another embodiment, the PPU 300 is included in a system-on-a-chip (SoC) along with one or more other logic units such as a reduced instruction set computer (RISC) CPU, a memory management unit (MMU), a digital-to-analog converter (DAC), and the like.

In one embodiment, the PPU 300 may be included on a graphics card that includes one or more memory devices 304 such as GDDR5 SDRAM. The graphics card may be configured to interface with a PCIe slot on a motherboard of a desktop computer that includes, e.g., a northbridge chipset and a southbridge chipset. In yet another embodiment, the PPU 300 may be an integrated graphics processing unit (iGPU) included in the chipset (i.e., Northbridge) of the motherboard.

FIG. 4 illustrates the streaming multi-processor 350 of FIG. 3, according to one embodiment. As shown in FIG. 4, the SM 350 includes an instruction cache 405, one or more scheduler units 410, a register file 420, one or more processing cores 450, one or more double precision units (DPUs) 451, one or more special function units (SFUs) 452, one or more load/store units (LSUs) 453, an interconnect network 480, a shared memory/L1 cache 470, and one or more texture units 490.

As described above, the work distribution unit 320 dispatches active grids for execution on one or more SMs 350 of the PPU 300. The scheduler unit 410 receives the grids from the work distribution unit 320 and manages instruction scheduling for one or more thread blocks of each active grid. The scheduler unit 410 schedules threads for execution in groups of parallel threads, where each group is called a warp. In one embodiment, each warp includes 32 threads. The scheduler unit 410 may manage a plurality of different thread blocks, allocating the thread blocks to warps for execution and then scheduling instructions from the plurality of different warps on the various functional units (i.e., cores 450, DPUs 451, SFUs 452, and LSUs 453) during each clock cycle.

In one embodiment, each scheduler unit 410 includes one or more instruction dispatch units 415. Each dispatch unit 415 is configured to transmit instructions to one or more of the functional units. In the embodiment shown in FIG. 4, the scheduler unit 410 includes two dispatch units 415 that enable two different instructions from the same warp to be dispatched during each clock cycle. In alternative embodiments, each scheduler unit 410 may include a single dispatch unit 415 or additional dispatch units 415.

Each SM 350 includes a register file 420 that provides a set of registers for the functional units of the SM 350. In one embodiment, the register file 420 is divided between each of the functional units such that each functional unit is allocated a dedicated portion of the register file 420. In another embodiment, the register file 420 is divided between the different warps being executed by the SM 350. The register file 420 provides temporary storage for operands connected to the data paths of the functional units.

Each SM 350 comprises L processing cores 450. In one embodiment, the SM 350 includes a large number (e.g., 192, etc.) of distinct processing cores 450. Each core 450 is a fully-pipelined, single-precision processing unit that includes a floating point arithmetic logic unit and an integer arithmetic logic unit. In one embodiment, the floating point arithmetic logic units implement the IEEE 754-2008 standard for floating point arithmetic. Each SM 350 also comprises M DPUs 451 that implement double-precision floating point arithmetic, N SFUs 452 that perform special functions (e.g., copy rectangle, pixel blending operations, and the like), and P LSUs 453 that implement load and store operations between the shared memory/L1 cache 470 and the register file 420. In one embodiment, the SM 350 includes 64 DPUs 451, 32 SFUs 452, and 32 LSUs 453.

Each SM 350 includes an interconnect network 480 that connects each of the functional units to the register file 420 and the shared memory/L1 cache 470. In one embodiment, the interconnect network 480 is a crossbar that can be configured to connect any of the functional units to any of the registers in the register file 420 or the memory locations in shared memory/L1 cache 470.

In one embodiment, the SM 350 is implemented within a GPU. In such an embodiment, the SM 350 comprises J texture units 490. The texture units 490 are configured to load texture maps (i.e., a 2D array of texels) from the memory 304 and sample the texture maps to produce sampled texture values for use in shader programs. The texture units 490 implement texture operations such as anti-aliasing operations using mip-maps (i.e., texture maps of varying levels of detail). In one embodiment, the SM 350 includes 16 texture units 490.

The PPU 300 described above may be configured to perform highly parallel computations much faster than conventional CPUs. Parallel computing has advantages in graphics processing, data compression, biometrics, stream processing algorithms, and the like.

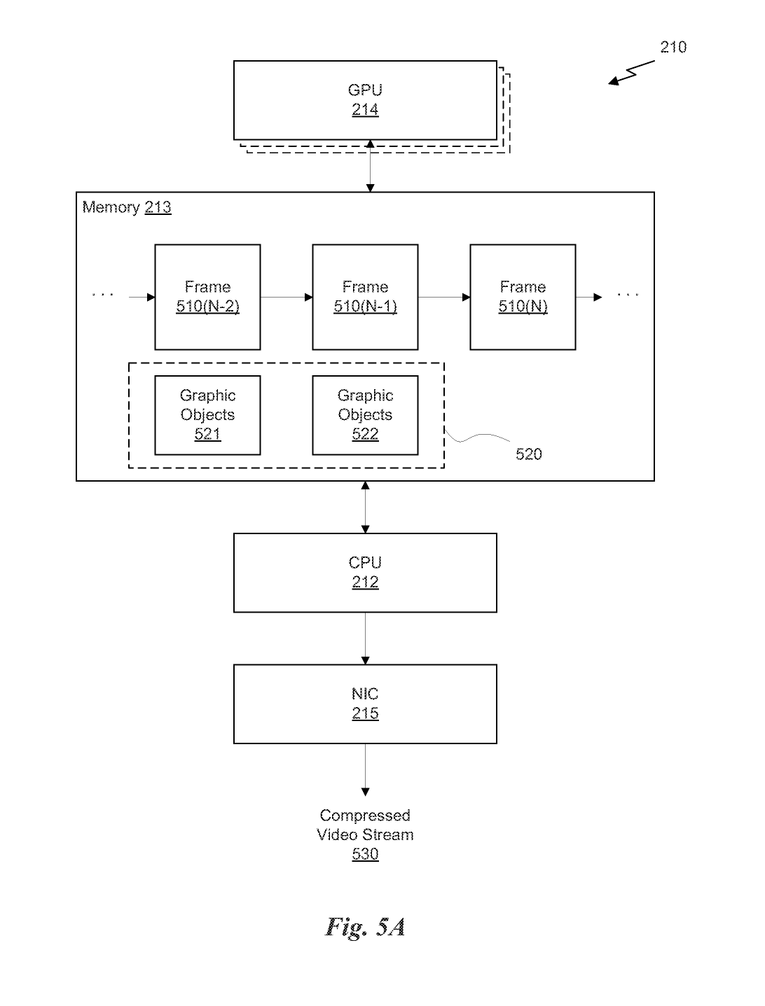

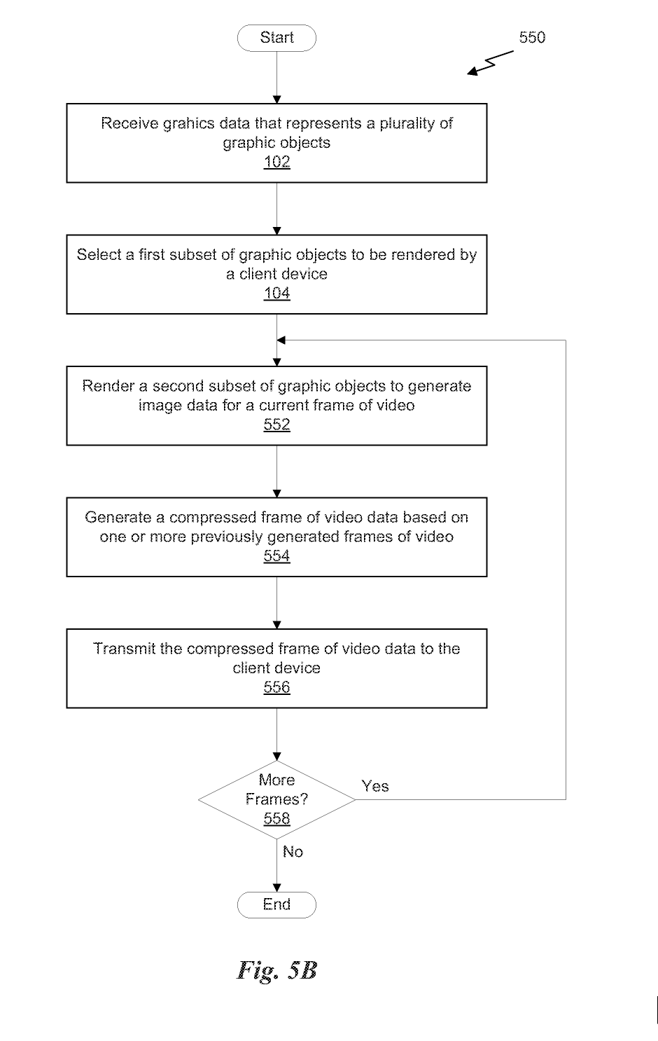

FIG. 5A illustrates at least a portion of the server computer 210 that generates a video stream for compositing with additional video data on a client computer 220, in accordance with one embodiment. As shown in FIG. 5A, the memory 213 includes graphics data 520 that represents a 3D model. The graphics data 520 includes a first portion that includes the first subset of graphic objects 521 selected by the server computer 210 to be rendered by the client computer 220 and a second portion that includes the second subset of graphic objects 522 to be rendered by the server computer 210. The server computer 210 includes a GPU 214 that generates one or more frames of video data 510 stored in a memory 213 based on the graphics data 520. The memory 213 may be a local memory associated with the server computer 210 or a network accessible memory such as cloud storage made available as a service via a provider such as Amazon™ S3 (Simple Storage Service) storage. Each frame 510 of video data is a rendered image that represents the second subset of graphic objects 522 at a particular point in time. The time may be represented by adding a time stamp to metadata embedded within the frame 510 of video data. The GPU 214 (or CPU 212) may be configured to compress the frames 510 of video data to generate compressed video data 530 that is streamed to the client computer 220 via the NIC 215.

The pixels in the frame 510 of video data associated with the first subset of graphic objects 521 may include a constant value that indicates that the pixels are associated with pixels to be rendered by the client computer 220. By filling such pixels with a constant value (e.g., color), the pixels may be efficiently compressed using techniques known to those of skill in the art. For example, the MPEG-4 AVC standard describes intra-frame compression techniques that enable blocks of pixels with similar colors to be efficiently compressed. In another embodiment, the constant value for a 32-bit pixel (e.g., 8 bits per channel in RGBA) may be zero, and each frame 510 of video data is run-length encoded to reduce the bandwidth of the frames 510 of video data.

Again, the GPU 214 may generate one frame 510 of video data at a time and transmit each frame 510 of video data to the client computer 220. In another embodiment, the server computer 210 may buffer one or more frames 510 of video in the memory 213 and compress the one or more frames 510 of video using a video codec such as MPEG-4 AVC or H.264. It will be appreciated that buffering one or more frames 510 of video in the memory 213 before transmitting a compressed video stream to the client computer 210 may cause a noticeable lag of a couple of frames at the client computer 210. Consequently, in one embodiment, the number of buffered frames 510 of video may be limited to minimize the experienced lag at the client computer 220.

For example, the GPU 214 may generate multiple frames 510 of video data in succession. As shown in FIG. 5A, a current frame 510(N) is stored in the memory 213 as the GPU 214 renders the graphic objects visible in the current frame 510(N). The memory 213 also includes one or more previously generated frames of video data (e.g., 510(N−1), 510(N−2), etc.). Once the server computer 210 has generated the current frame 510(N) of video data, the server computer 210 may generate a compressed frame of video data for output to the stream of compressed video data transmitted to the client computer 220. The server computer 210 may generate a compressed frame of video data that corresponds to a previously generated frames of video data (e.g., 510(N−1), 510(N−2), etc.). In one embodiment, the server computer 210 implements an MPEG-4 AVC codec for generating the stream of compressed video data. The MPEG-4 AVC codec may encode video comprising a group of pictures that includes 1-frames (intra-coded frames), P-frames (predictive-coded frames), and B-frames (bi-directionally, predictive-coded frames). In one embodiment, the group of pictures comprises a first I-frame followed by groups of P-frames and B-frames. Following the I-frame are one or more B-frames followed by a P-frame. Alternating B-frames and P-frames complete the group of pictures. For example, a group of pictures may comprise the following pattern IBBPBBPBBPBBPBBI of compressed frames of video.

In order to implement video compression, the server computer 210 may buffer a number of previously generated frames 510 of video in the memory 213 such that the compression algorithm can generate B-frames and P-frames based on previously generated frames of video. For example, the server computer 210 may buffer a number of previously generated frames of video equal to the size of a group of pictures. In another embodiment, the server computer 210 may limit the number of frames buffered to minimize lag at the client computer. The format of the group of pictures may be selected based on a threshold number of frames to be buffered. For example, if the number of frames 510 of video to be buffered is limited to 5 frames, then the group of pictures may have a format of IBPB that is repeated for each group of pictures. Consequently, after generating a current frame 510(N) of video data, the server computer 210 may generate a compressed frame of video data corresponding to a previously generated frame of video data such that P-frames or B-frames may be generated using efficient compression techniques.

FIG. 5B illustrates a flowchart of a method 550 for generating video data streamed to a client computer 220, in accordance with one embodiment. The method 550 begins with steps 102 and 104, described above in conjunction with FIG. 1. At step 552, the server computer 210 renders a second subset of graphic objects to generate image data for a current frame 510(N) of video. At step 554, the server computer 210 generates a compressed frame of video data based on one or more previously generated frames of video data (e.g., 510(N−1), 510(N−2), etc.). At step 556, the server computer 210 transmits the compressed frame of video data to the client computer 220. At step 558, the server computer 210 determines if there are more frames of video to be generated. If there are no more frames of video to be generated, then the server computer 210 terminates the communications channel with the client computer 220 and the method 550 terminates. However, if there are more frames of video to be generated, then the method 550 returns to step 552 and the second subset of graphic objects may be transformed and rendered to generate the next frame 510(N+1) of video in the memory 213.

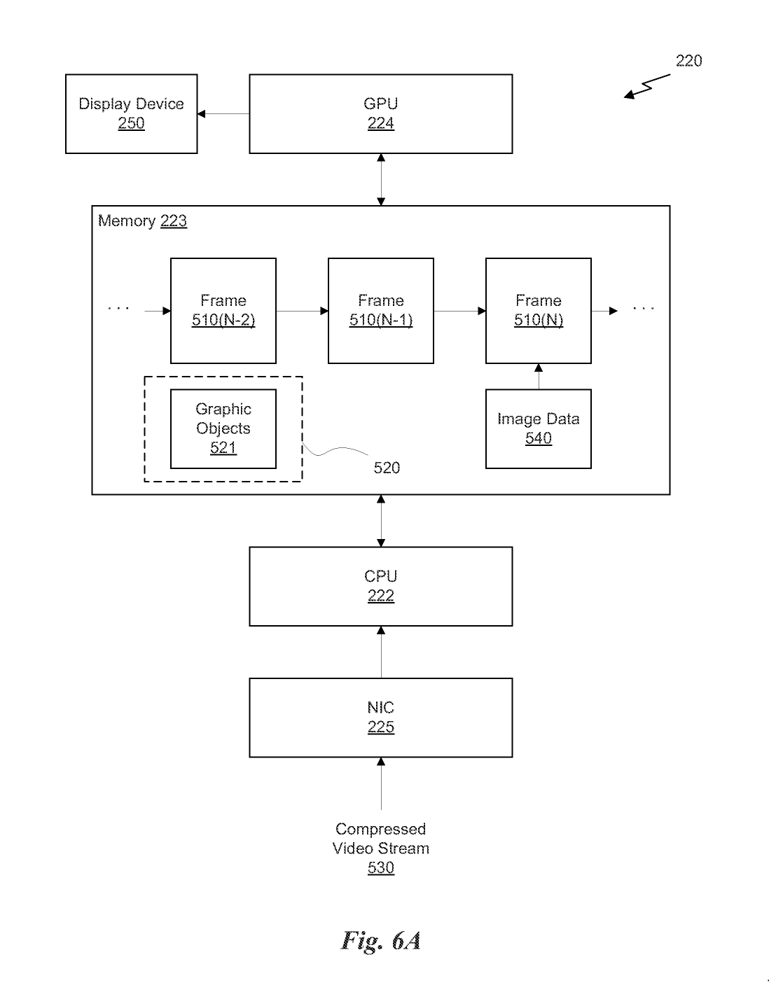

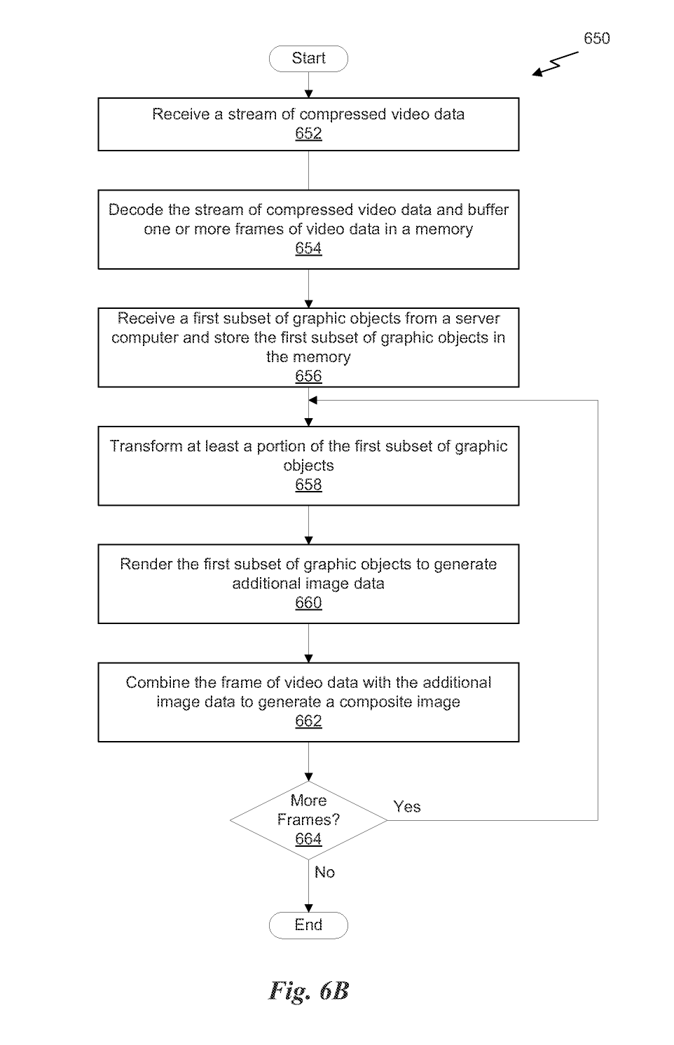

FIG. 6A illustrates at least a portion of a client computer 220 that generates images for display by combining compressed video data 530 generated by a server computer 210 with additional image data 540 generated by the client computer 220, in accordance with one embodiment. As shown in FIG. 6A, the client computer 220 receives the compressed video data 530 from the server computer 210 via the NIC 225. The GPU 224 (or CPU 222) is configured to decode the compressed video data 530 to generate the frames 510 of video data stored in the memory 223. In addition, the client computer 220 receives the first subset of graphic objects 521 from the server computer 210. The data representing the first subset of graphic objects 521 may be sent at the beginning of a session established between the client computer 220 and the server computer 210.

In one embodiment, the data representing the first subset of graphic objects 521 is sent once and then the data is updated periodically (e.g., every frame) based on commands sent from the server computer 210 to the client computer 220. For example, the server computer 210 may send commands that specify a transform (i.e., translation, rotation, scale, etc.) of the graphic objects in the first subset of graphic objects 521. The server computer 210 may also send commands that transform only a portion of the first subset of graphic objects. For example, the command may cause a translation and/or rotation of the graphic objects associated with a player weapon, while other graphic objects remain static. Thus, a large amount of graphics data may be transmitted to the client computer 220 before the first frame of video is sent to the client computer 220, and then smaller amounts of data that specify commands for the client computer 220 to modify the data are sent in addition to each frame 510 of video data. The same graphics data may then be reused for multiple frames of video without having to resend the graphics data via the network 230.

The client computer 220, via GPU 224, is configured to render the graphics data for the first subset of graphic objects 521 to generate additional image data 540 that represents the first subset of graphic objects 521. The first subset of graphic objects 521 may be transformed based on one or more commands embedded within the compressed video data 530 received from the server computer 210. Then, the additional image data 540 is blended with a corresponding frame 510 of video data to generate an image for display on the display device 250. The image is transmitted to the display device 250 via a video interface and displayed for a user.

FIG. 6B illustrates a flowchart of a method 650 for displaying images composited from compressed video data 530 received from a server computer 210 and additional image data 540 generated by a client computer 220, in accordance with one embodiment. At step 652, the client computer 220 receives a stream of compressed video data 530. In one embodiment, the compressed video data 530 may be a stream of images compressed via an image codec such as JPEG images. In another embodiment, the compressed video data 530 may be a stream of video encoded with a video compression technique such as MPEG-4 AVC or H.264. At step 654, the client computer 220 decodes the stream of compressed video data 530 and buffers one or more frames 510 of video data in a memory 223. At step 656, the client computer 220 receives a first subset of graphic objects 521 from the server computer 210 and stores the first subset of graphic objects 521 in the memory 223. At step 658, the client computer 220 transforms at least a portion of the first subset of graphic objects 521. In one embodiment, the client computer 220 performs the transformation based on one or more commands embedded in the stream of compressed video data 530.

At step 660, the client computer 220 renders, via the GPU 224, the first subset of graphic objects 521 to generate the additional image data 540. The additional image data 540 corresponds to a particular frame of video. In one embodiment, the server computer 210 and the client computer 220 may synchronize a frame 510 of video data generated by the server computer 210 with a frame of additional image data 540 generated by the client computer 220 using timestamps. A timestamp value may be embedded in the stream of compressed video data along with each frame 510 of video data to mark the frame with a particular timestamp that is then matched against a timestamps associated with each frame of additional image data 540 generated by the client computer 220. At step 662, the client computer combines the frame 510 of video data with the frame of additional image data 540. In one embodiment, for each pixel in the frame 510 of video data having a specific value, the client computer 220 replaces the value of the pixel with a value of a corresponding pixel in the frame of additional image data 540. In another embodiment, the client computer 220 blends each of the pixels in the frame 510 of video data with each of the corresponding pixels in the frame of additional image data 540. At step 664, the client computer 220 whether there are more frames in the stream of compressed video data. If so, then the method returns to step 658 to transform at least a portion of the graphic objects and generate the next image for display. However, if there are no more frames in the stream of compressed video data, then method 650 terminates.

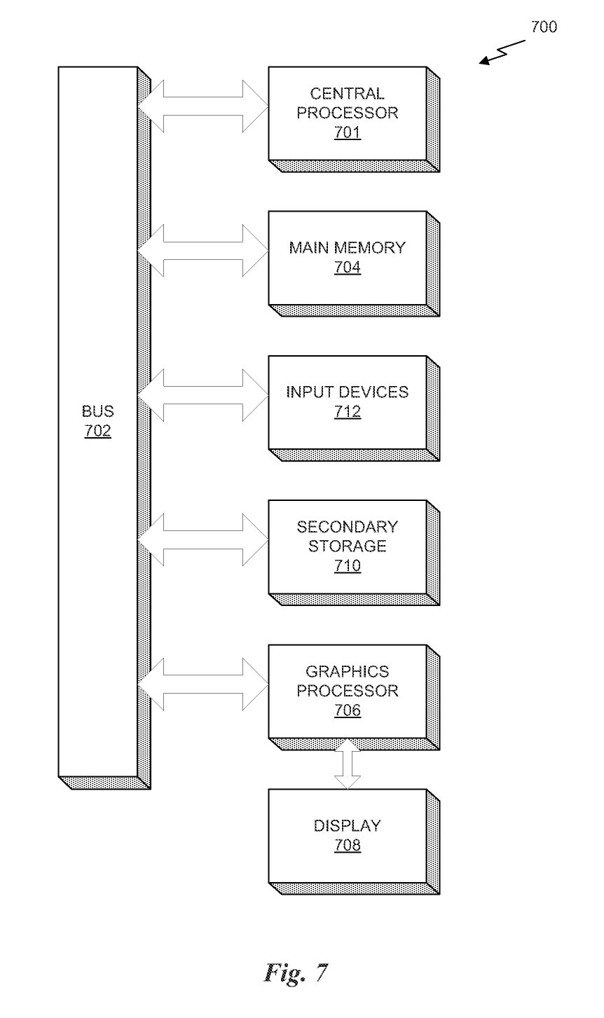

FIG. 7 illustrates an exemplary system 700 in which the various architecture and/or functionality of the various previous embodiments may be implemented. As shown, a system 700 is provided including at least one central processor 701 that is connected to a communication bus 702. The communication bus 702 may be implemented using any suitable protocol, such as PCI (Peripheral Component Interconnect), PCI-Express, AGP (Accelerated Graphics Port), HyperTransport, or any other bus or point-to-point communication protocol(s). The system 700 also includes a main memory 704. Control logic (software) and data are stored in the main memory 704 which may take the form of random access memory (RAM).

The system 700 also includes input devices 712, a graphics processor 706, and a display 708, i.e. a conventional CRT (cathode ray tube), LCD (liquid crystal display), LED (light emitting diode), plasma display or the like. User input may be received from the input devices 712, e.g., keyboard, mouse, touchpad, microphone, and the like. In one embodiment, the graphics processor 706 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 700 may also include a secondary storage 710. The secondary storage 710 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 704 and/or the secondary storage 710. Such computer programs, when executed, enable the system 700 to perform various functions. The memory 704, the storage 710, and/or any other storage are possible examples of computer-readable media.

In one embodiment, the architecture and/or functionality of the various previous figures may be implemented in the context of the central processor 701, the graphics processor 706, an integrated circuit (not shown) that is capable of at least a portion of the capabilities of both the central processor 701 and the graphics processor 706, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 700 may take the form of a desktop computer, laptop computer, server, workstation, game consoles, embedded system, and/or any other type of logic. Still yet, the system 700 may take the form of various other devices including, but not limited to a personal digital assistant (PDA) device, a mobile phone device, a television, etc.

Further, while not shown, the system 700 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving graphics data that represents a plurality of graphic objects;
selecting a first subset of graphic objects from the plurality of graphic objects to be rendered by a client device;
transmitting the first subset of graphic objects to the client device;
rendering a second subset of graphic objects from the plurality of graphic objects to generate image data for a frame of video; and
transmitting the image data to the client device,
wherein the client device is configured to render the first subset of graphic objects to generate additional image data and combine the additional image data with the image data to generate a combined image for display.

2. The method of claim 1, further comprising compressing the image data to generate compressed image data, wherein the compressed image data is transmitted to the client device in lieu of the image data.

3. The method of claim 1, wherein the first subset of graphic objects and the second subset of graphic objects comprise a set of graphic objects visible on a surface displayed by the client device.

4. The method of claim 1, further comprising:
rendering the second subset of graphic objects to generate image data for a second frame of video;
compressing the image data for the second frame of video based on the image data for the first frame of video to generate compressed video data; and
transmitting the compressed video data to the client device.

5. The method of claim 4, wherein the compressing is performed using an MPEG-4 AVC video codec.

6. The method of claim 4, wherein the compressing is performed using an H.264 video codec.

7. The method of claim 1, wherein selecting the first subset of graphic objects comprises:
identifying one or more graphic objects associated with a heads-up-display (HUD); and
selecting the one or more graphic objects associated with the HUD as the first subset of graphic objects.

8. The method of claim 1, wherein selecting the first subset of graphic objects comprises:
identifying one or more graphic objects having a depth that is less than a threshold value; and
selecting the one or more graphic objects having depths less than the threshold value as the first subset of graphic objects.

9. The method of claim 1, further comprising:
receiving input from the client device;
transforming the second subset of graphic objects based on the input; and
embedding one or more commands within the image data, wherein the one or more commands specify operations that cause the client device to transform the first subset of graphic objects based on the input.

10. The method of claim 1, further comprising embedding a timestamp within the image data that indicates a time associated with a frame of video corresponding to the image data.

11. The method of claim 1, wherein the transmitting is performed via a network that associates the client device with an Internet Protocol address.

12. The method of claim 1, wherein rendering the second subset of graphic objects is performed via two or more graphics processing units.

13. The method of claim 12, wherein the two or more graphics processing units comprise a render farm that includes a plurality of render nodes, each render node including a memory and at least one graphics processing unit that are coupled to the network.

14. A non-transitory computer-readable storage medium storing instructions that, when executed by a processor, cause the processor to perform steps comprising:
receiving graphics data that represents a plurality of graphic objects;
selecting a first subset of graphic objects from the plurality of graphic objects to be rendered by a client device;
transmitting the first subset of graphic objects to the client device;
rendering a second subset of graphic objects from the plurality of graphic objects to generate image data for a frame of video; and
transmitting the image data to the client device,
wherein the client device is configured to render the first subset of graphic objects to generate additional image data and combine the additional image data with the image data to generate a combined image for display.

15. The computer-readable storage medium of claim 14, the steps further comprising:
rendering the second subset of graphic objects to generate image data for a second frame of video;
compressing the image data for the second frame of video based on the image data for the first frame of video to generate compressed video data; and
transmitting the compressed video data to the client device.

16. The computer-readable storage medium of claim 14, the steps further comprising:
receiving input from the client device;
transforming the second subset of graphic objects based on the input; and
embedding one or more commands within the image data, wherein the one or more commands specify operations that cause the client device to transform the first subset of graphic objects based on the input.

17. A system, comprising:
a server device that includes one or more graphics processors and a memory, the server device configured to:
receive graphics data that represents a plurality of graphic objects,
select a first subset of graphic objects from the plurality of graphic objects to be rendered by a client device,
transmit the first subset of graphic objects to the client device,
render a second subset of graphic objects from the plurality of graphic objects to generate image data for a frame of video, and
transmit the image data to the client device; and
a client device that includes one or more graphics processors and a memory, the client device configured to:
render the first subset of graphic objects to generate additional image data, and
combine the additional image data with the image data to generate a combined image for display.

18. The system of claim 17, wherein the server device and the client device communicate via a network.

19. The system of claim 17, wherein the server device is further configured to:
render the second subset of graphic objects to generate image data for a second frame of video;
compress the image data for the second frame of video based on the image data for the first frame of video to generate compressed video data; and
transmit the compressed video data to the client device.

20. The system of claim 17, wherein the client device comprises a system-on-chip (SoC) that further includes a central processing unit (CPU) and a network interface controller (NIC).
